(19) United States
(12) Patent Application Publication
(10) Pub. No.: US 2021/0295387 A1
(43) Pub. Date: Sep. 23, 2021

(54) SYSTEMS AND METHODS FOR PROVIDING AN OFFER BASED ON VEHICLE IDENTIFICATION

(71) Applicant: Rovi Guides, Inc., San Jose, CA (US)

(72) Inventors: Peter Jason Calvert, Limerick, PA (US); Christopher Lidaka, Apex, NC (US)

(21) Appl. No.: 16/826,535

(22) Filed: Mar. 23, 2020

(51) Int. Cl. G06Q 30/02

(52) U.S. Cl. CPC G06Q 30/0266; G06Q 30/0222; G06Q 30/0267

(57) ABSTRACT

Methods and systems are employed for providing an offer to a vehicle based on the vehicles geographical location and upon the vehicle arriving at the merchant, applying the offer to a transaction. The offer is applied based on data identifying the vehicle transmitted from a first network and the second network. The offer can be based on a geographical location of the vehicle in proximity to a merchant.

### BACKGROUND

The present disclosure relates generally to systems and methods for providing vehicle-associated merchant offers and, more particularly, systems and methods for providing an offer based on vehicle identification.

### SUMMARY

A user of a mobile device while traveling in a vehicle may receive offers on the mobile device from merchants based on the location of the user. Using the offers typically requires the user to exit the vehicle with the mobile device and enter a physical storefront of the merchant. For example, the user while traveling in a vehicle receives an offer from a merchant in a path of the vehicle that may suggest visiting the merchant, to accept and claim the offer (i.e., purchase a cup of coffee with a discount). Typically, to claim the offer, the user must exit the vehicle with the mobile device, or approach a drive-through window with the mobile-device in-hand.

To overcome this problem, methods and systems are disclosed for providing a network-connected vehicle capable of receiving, accepting and claiming an offer from a merchant over a network for in-vehicle use. In one embodiment, the system may utilize a vehicle identification when approaching a merchant and accept an offer over a network for in-vehicle use. In one embodiment, for example, the system determines that the vehicle is within a first threshold distance of a merchant system (e.g., Starbucks®, Wendy's®, etc.) and provides an offer based on the vehicle's geographical location. As the vehicle travels along a path, a merchant associated with a merchant system sends out an offer (e.g., upgrade from small coffee to a large coffee for free) to all vehicles within a range of the merchant via a network for in-vehicle use. The offer from the merchant associated with the merchant system may be presented on an interface in the vehicle for a user or occupant of the vehicle. For example, as the vehicle moves, a coffee shop (e.g., Starbucks®) location distributes an offer of a free upgrade to all vehicles within a first distance range (e.g., 10 miles) of the Starbucks® location, and provides an opportunity for the user or occupant of the vehicle to accept the offer.

Upon the user or occupant of the vehicle accepting the offer, via the vehicle's interface, the vehicle transmits to the merchant associated with the merchant system, via a first network, data identifying the vehicle. In some examples, the first network and a second network may be the same network. The first network can be any one of a 3G network, a 4G network, an LTE network, an LTE-Advanced (LTE-A) network, a Global System for Mobile Communications (GSM) network, a Code Division Multiple Access (CDMA) network, a Wideband Code Division Multiple Access (WCDMA) network, an Ultra Mobile Broadband (UMB) network, a High-Speed Packet Access (HSPA) network, an Evolution Data Optimized (EV-DO) network, or a Universal Mobile Telecommunications System (UMTS) network capable of transmitting data over the network. Data identifying the vehicle may include a unique identified data provided for the vehicle (e.g., a VIN number, a license plate number or partial license plate number along with vehicle make, model, and color, a randomly created unique number associated with the vehicle, etc.).

As the user or occupant of the vehicle drives the vehicle to the merchant and the system determines that the vehicle is within a second threshold distance (e.g., 100 feet) of a merchant system, the vehicle may transmit data identifying the vehicle via second distance network (e.g., Bluetooth®) to the merchant system. As the vehicle approaches the merchant (e.g., Starbucks) a signal from the vehicle is transmitted to the merchant. That is, a vehicle can be identified by a second network that reads an RF signal of the vehicle as the vehicle approaches the merchant. The second network can be, for example, a local network, a Wi-Fi network, an Apple Air-Drop transmission, a Zigbee network, or a Bluetooth® network. In some examples, the second network is identical to the first network.

The system, in response to determining that the data identifying the vehicle transmitted from the first network matches the data identifying the vehicle transmitted from the second network, applies the offer to a transaction for the user or occupant of the vehicle. In another example, a system determines that a vehicle is within 10 miles of a Starbucks and sends (e.g., transmits over a network) an offer to the vehicle for an upgrade of a product. The offer may be accepted by the user or occupant of the network-connected vehicle. Upon the vehicle approaching a drive-thru of the Starbucks, the vehicle sends a second ID of the vehicle via a second network to the Starbucks. Based on the merchant confirming that first ID of the vehicle and the second ID of the vehicle are identical, the merchant offer is applied to the transaction for the user or occupant of the vehicle.

Based on providing a network-connected vehicle capable of receiving, accepting and claiming an offer from a merchant over a network for in-vehicle use, the system applies the offer to the transaction seamlessly and effortlessly for the user or occupant of the vehicle. The vehicle can apply the offer to a transaction for an enhanced and improved driving experience, where the user or occupant of the vehicle can claim a product from the merchant seamlessly and effortlessly by the vehicle assisting in the transaction.

In another example, a Global Positioning System (GPS) can be used for tracking the location of the vehicle. For example, as the vehicle approaches a first threshold of the merchant, the merchant detects the vehicle and sends out an offer for an upgrade to generate additional foot traffic and good will with a potential client. As the user or occupant of the vehicle accepts the offer, the vehicle's location may be tracked to determine when the vehicle is near a second threshold of the merchant. When the vehicle crosses over the second threshold, the vehicle's location may be transmitted to the merchant via GPS signal, and proceed to apply the offer to a transaction for the user or occupant of the vehicle. For example, the vehicle's GPS coordinates may be tracked as the vehicle moves along a path, and as the vehicle's coordinates approach the merchant, the system can determine that the vehicle is near the merchant and within the proximity of the vehicle to the merchant to apply the offer to a transaction.

Such an improvement to in-vehicle entertainment systems and interfaces can improve the driving experience of the vehicle's occupants (e.g., processing offers of coupons) without requiring any additional input from the user after accepting the offer from the merchant.

### BRIEF DESCRIPTION OF THE DRAWINGS

The above and other objects, advantages, and improvements of the disclosure will be apparent upon consideration of the following detailed description, taken in conjunction with the accompanying drawings, in which like reference characters refer to like parts throughout, and in which:

FIG. 1 shows an illustrative example of a scenario for providing an offer based on vehicle identification, in accordance with one embodiment;

FIG. 2 depicts a block diagram of an illustrative example of a user equipment device, in accordance with one embodiment;

FIG. 3 depicts an example of an illustrative system implementing the user equipment device, in accordance with one embodiment;

FIG. 4 depicts a block diagram of an illustrative example of a user equipment device, in accordance with one embodiment;

FIG. 5 depicts an illustrative example of a vehicle featuring a content display, in accordance with one embodiment;

FIG. 6 depicts an illustrative example of a vehicle content interface application for displaying content in a vehicle, in accordance with one embodiment;

FIG. 7 depicts an illustrative example of a vehicle transmitting data to the merchant to apply the offer to a transaction, in accordance with one embodiment;

FIG. 8 is a flowchart of an illustrative process for providing an offer based on vehicle identification, in accordance with one embodiment;

FIG. 9 depicts an example of an illustrative flowchart of the process of determining the vehicle is within the first threshold distance, in accordance with one embodiment; and

FIG. 10 depicts an example of an illustrative flowchart of the process of providing an offer based on vehicle identification information and time stamps, in accordance with one embodiment.

### DETAILED DESCRIPTION

Methods and systems are disclosed herein for providing a network-connected vehicle capable of receiving, accepting and claiming an offer from a merchant over a network for in-vehicle use. In one embodiment, a method provides an offer to a user or occupant of a vehicle via a network, the vehicle transmits acceptance of the offer and upon the vehicle arriving at the merchant, the vehicle transmits a signal for the merchant to apply the offer to the transaction of the user or occupant of the vehicle (e.g., Free Small to Large coffee upgrade), automatically.

As used herein, “a vehicle content interface application” refers to a form of content that through an interface facilitates access to audio, music, news, advertisements and podcast content on one or more display devices operating within the vehicle. In some embodiments, the vehicle content interface application may be provided as an online application (i.e., provided on a website), or as a stand-alone application on a server, user device, etc. The vehicle content interface application may also communicate with a vehicle antenna array or telematics array to receive content (e.g., offers) via a network. Various devices and platforms that may implement the vehicle content interface application are described in more detail below. In some embodiments, the vehicle content interface application and/or any instructions for performing any of the embodiments discussed herein may be encoded on computer-readable media. Computer-readable media includes any media capable of storing instructions and/or data. The computer-readable media may be transitory, including, but not limited to, propagating electrical or electromagnetic signals, or may be non-transitory including, but not limited to, volatile and nonvolatile computer memory or storage devices such as a hard disk, USB drive, DVD, CD, media card, register memory, processor caches, Random Access Memory (“RAM”), etc. For example, the disclosed vehicle content interface application can be implemented by executing instructions on a computer-readable media to perform the disclosed methods.

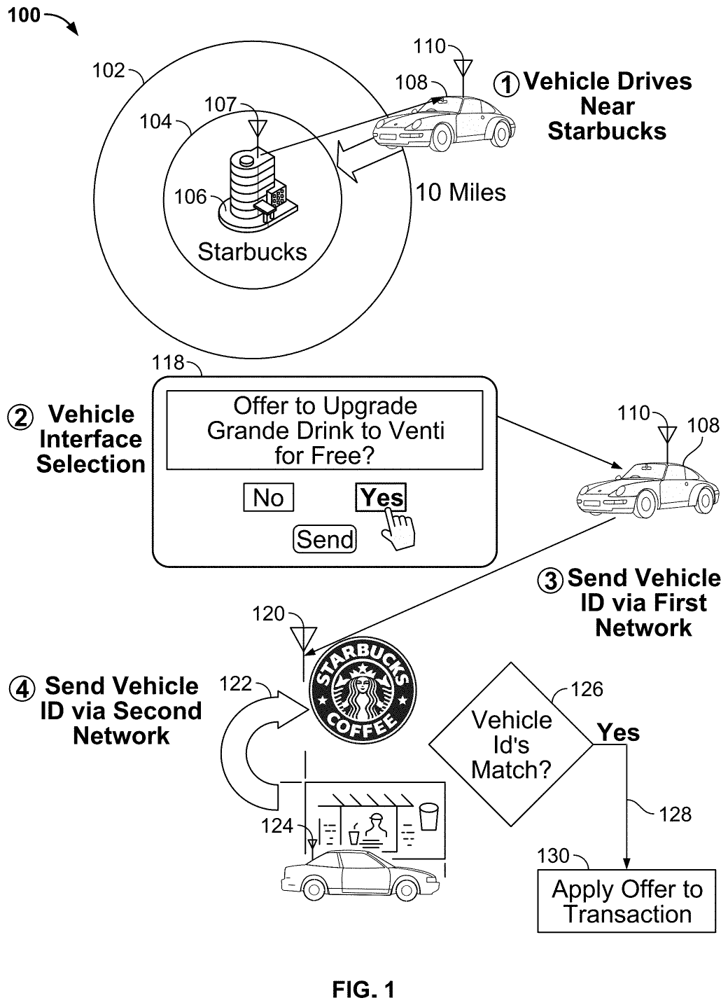

FIG. 1 shows an illustrative example for generating a playlist based on variety of content types and geographical origins that are available to a user or occupant of the vehicle 108. In one embodiment, as shown in FIG. 1, a vehicle 108 having a vehicle antenna 110, and a vehicle interface 118 receives signals (e.g., offers) from a merchant 106 (e.g., Starbucks, Wendy's, or any other merchant). The vehicle antenna 110 can receive offers (e.g., offer for an upgrade, offer for discounted merchandise, etc.) based on the geographical location of the vehicle and a merchant's proximity to the vehicle. The vehicle antenna 110 is a receiver and transmitter, and function to receive or transmit signals. Vehicle antenna 110 can be, e.g., a shark fin antenna array or a flat antenna array formed on a roof of a vehicle. According to an embodiment, the vehicle antenna 110 may communicate over a wireless network such as a wireless network that operates according to a 5G specification or standard. In another embodiment, the wireless network includes a wireless network that operates according to a specification or a standard other than a 5G specification or standard. For example, the wireless network may operate as a 3G network, a 4G network, an LTE network, an LTE-Advanced (LTE-A) network, a Global System for Mobile Communications (GSM) network, a Code Division Multiple Access (CDMA) network, a Wideband Code Division Multiple Access (WCDMA) network, an Ultra Mobile Broadband (UMB) network, a High-Speed Packet Access (HSPA) network, an Evolution Data Optimized (EV-DO) network, a Universal Mobile Telecommunications System (UMTS) network, an Apple Air-Drop, or some other type of wireless network (e.g., an ad hoc network, a non-land-based wireless network, etc.). Vehicle antenna 110 can be coupled to one or more modems to communicate over any number of the above wireless networks. The merchant 106 may include a database (not shown) to store all received vehicle identification IDs and transmitted offers to vehicles in geographical proximity to the merchant or having a predicted path of the vehicle that travels near the merchant. The database can be coupled to a server or a collection of servers designed to receive and store the vehicle identification IDs and compare the vehicle ID as transmitted upon acceptance of an offer and upon arrival of the vehicle at the merchant's location. The transmission of information (e.g., offers, vehicle identification IDs, etc.) between the vehicle and the merchant can include over-the-air digital signals or over-the-air analog signals. The system may be provided for converting over-the-air, analog, or digital signals to MPEG signals for storage.

Vehicle 108 may travel along a road and be within a first threshold distance 102 of a merchant 106. The first threshold distance 102 may be predetermined based on the system selections, for example, the first threshold distance 102 may include a predetermined distance of a radius of 10 miles. The distance between the vehicle and the merchant may vary and can be adjusted by the user, occupant of the vehicle or merchant. In one example, the user may want to know all Starbucks within 25 miles, and can adjust the first threshold distance accordingly. Upon determining that the vehicle is within the first threshold distance (e.g., 10 mile radius, 25 miles, etc.) of a merchant (e.g., Starbucks) associated with a merchant system, the system may present an offer to the vehicle for an upgrade of merchandise. The offer may be presented from the merchant or from a merchant system centrally located via the merchant antenna 107 to the vehicle antenna 110. The offer may be presented in the vehicle 108 on a vehicle interface 118. The offer may be from a merchant associated with the merchant system or a centrally located distribution center associated with the merchant system. In other examples, the first threshold distance 102 can be adjusted by a user or occupant of a vehicle or remotely by a server or a merchant (e.g., a user may want to know all Starbucks within 25 miles).

A user or occupant of the vehicle 108 can perform a selection via the vehicle interface 118, and, in response to the user or occupant of the vehicle 108 accepting the offer, the vehicle antenna 110, via a first network, may transmit the acceptance of the offer and a vehicle identification ID to the merchant associated with the merchant system or a centrally located distribution center associated with the merchant system. As the user or occupant of the vehicle approaches the merchant, within a second threshold distance 104 (e.g., 100 feet), the vehicle may transmit data identifying the vehicle via second network 122 to the merchant system 120. The system may compare 126 the vehicle identification from the first network and the second network to determine that the same vehicle accepted the offer. The vehicle may transmit the data identifying the vehicle using a radio frequency (RF) signal. Upon determining that the data identifying the vehicle from the first network matches the data identifying the vehicle from the second network (“Yes” at 126), at 128 the system applies the offer to a transaction 130 for the vehicle. For example, the user or occupant of a vehicle, while driving within a first threshold distant (e.g., 10 miles, 25 miles, etc.) of a Starbucks, may receive an offer from Starbucks for a free upgrade. Upon acceptance of the offer for a free upgrade, the vehicle may transmit vehicle information to the Starbucks as part of a verification method, and, as the vehicle drives to the Starbucks to claim the offer, a second data of vehicle identification is transmitted over a second network to confirms that the vehicle identification data matches. When the vehicle identifications from the first and the second network match, Starbucks automatically applies the offer to the transaction made by the user or occupant of the vehicle.

The system further includes a vehicle 108 with a vehicle antenna array 110 and a vehicle interface 118. In one embodiment, the vehicle is an autonomous or semi-autonomous vehicle, a vehicle capable of sensing its environment and moving safely with little or no human input. The vehicle can be an network-connected vehicle, a vehicle that can communicate bidirectionally with other systems outside of the vehicle. The vehicle can communicate bidirectionally via the vehicle antenna array 110 with the merchant 106 to facilitate an acceptance of an offer based on the selections and the transmission of the offer. The display 502 in the vehicle 500 may also display audio user interface element 601 among other user interface elements, which are discussed below with reference to FIG. 6. In one example, when a user or occupant of a vehicle selects on a display 502 the audio user interface element 601, the vehicle content interface application may display the user interface 600 with options for selection. For example, the user interface 600 may provide a selection of different entertainment systems including prompts 602 for offers from merchants. In the prompt 602, a Starbucks offer 604 is presented as an example, with the details of the offer (e.g., “Upgrade from a Grande to Venti for Free”) being presented at 606. The prompt provides an opportunity to reject 608 or accept 610 the offer. Upon accepting the offer, the vehicle antenna 110 may transmit a signal to the merchant of the offer acceptance and the vehicle identification information. Upon rejecting the offer, the vehicle antenna array 110 may transmit a signal to the merchant that the offer is rejected.

In some embodiments, merchant offers are presented based on the geographical location of the vehicle and the proximity to the merchant. The system identifies a geographical location of the vehicle and a geographical location of a merchant providing an offer. The system determines, based on the geographical location of the vehicle and the proximity of the vehicle to the merchant, to provide an offer to the vehicle. When the geographical location of the vehicle is within range of the merchant associated with the merchant system, the system provides an offer to the vehicle. Upon the acceptance of the offer by the user or occupant of the vehicle, the vehicle transmits data (first data identifying the vehicle) from the vehicle to the merchant system, and upon arriving near the merchant, the vehicle transmits second data (second data identifying the vehicle) from the vehicle to the merchant system. Upon acceptance of the offer, the system may include a first combination of first data identifying the vehicle and first geographical location (e.g., 10 miles, 25 miles, etc.) and a second combination of second data identifying the vehicle and second geographical location. For example, the first combination includes a vehicle identification and a first geographical location (e.g., 10 miles, 25 miles, etc.) and the second combination includes a vehicle identification and a second geographical location (e.g., near merchant). The transmission of the first geographical location can be triggered by approaching the merchant within the first threshold distance. The first threshold distance can be adjusted by a user or occupant of a vehicle or remotely by a server or a merchant (e.g., a user may want to know all Starbucks within 25 miles). The second geographical location is a predetermined radius from the merchant, for example within a hundred feet of the merchant. The first combination and the second combination include the same vehicle identification and different geographical locations (e.g., 10 miles away from merchant and near merchant).

The system generates the offers based on a user or occupant of a vehicle's preferences for offers stored in a database of the merchant. For example, based on a selection, the system searches for metadata of a user profile and determines a predicted path that the user or occupant of the vehicle will travel that will be close to the merchant and proposes an offer to the user or occupant of the vehicle.

In some embodiments, the merchant may provide a threshold time gap by which the offer must be claimed (i.e., time between offer being accepted and applied). Such a process may incentivize the user or occupant of the vehicle to drive to the merchant to claim the offer. Upon and in response to receiving acceptance of the offer via the vehicle's interface, the system may also transmit a first-time stamp of offer acceptance and provide a threshold time gap (e.g., time between offer being accepted and applied). In some examples, the threshold time gap may be a predetermined time, for example, 30 minutes, or 15 minutes. In another example, the threshold time gap may vary based on the merchant. The system will, upon and in response to determining that the vehicle is within the second threshold distance (e.g., near merchant) of the merchant, transmits a second time stamp. As a result of the difference between the first-time stamp and the second stamp being less that the threshold time gap, the system may apply the offer to the transaction.

In some embodiments, the selection of offers may be optional, such that the offers can be automatically generated and presented to the user or occupant of the vehicle for consumption. For example, the user or occupant of the vehicle may enter a destination for the vehicle, a predicted path may be identified, and while in transit, the system identifies an offer from a merchant that is proximate (e.g., within a first threshold distance) to the predicted path, and prompts the user or occupant to accept an offer from the merchant. The first threshold distance can be a predetermined value (e.g., 10 miles), or an adjustable value (e.g., 2 miles, 4 miles, etc.) that the user or occupant can adjust based on preference. In some cases, the user or occupant of the vehicle can opt to receive only, for example, specific offers (e.g., from pizza restaurants or coffee shops). Further, the user or occupant of the vehicle has the option to enter a specific amount of time by which to space out the offers. For example, the user can accept an offer and proceed to claim it, and the system can postpone any additional offers along the path of the vehicle for an extended period, for example, 30 minutes, or as frequently as offers from merchants proximate to the predicted travel path are available.

In some embodiments, selections for destination, type of offers and frequency are entered in the user interface of the vehicle. The selections may include a destination and a plurality of offer types (e.g., coffee shops, donut shops, etc.). For example, entering the destination of the vehicle, the system determines the predicted path of the vehicle and searches for metadata for offers that match identified geographical locations of merchants proximate to the predicted path. The identified geographical locations of merchants transmit offers for presentation on an interface in the vehicle, for example, a discounted coffee from a coffee shop or a free donut with the purchase of half dozen donuts from a donut shop. The system provides the relevant information of offers based on the selection and the received offers from identified geographical locations of merchants in the database. Advantageously, this enhanced and improved in-vehicle entertainment system provides a seamless, efficient enjoyment by the user or occupant of the vehicle to claim an offer from a merchant without requiring any additional input from the user after accepting the offer from the merchant.

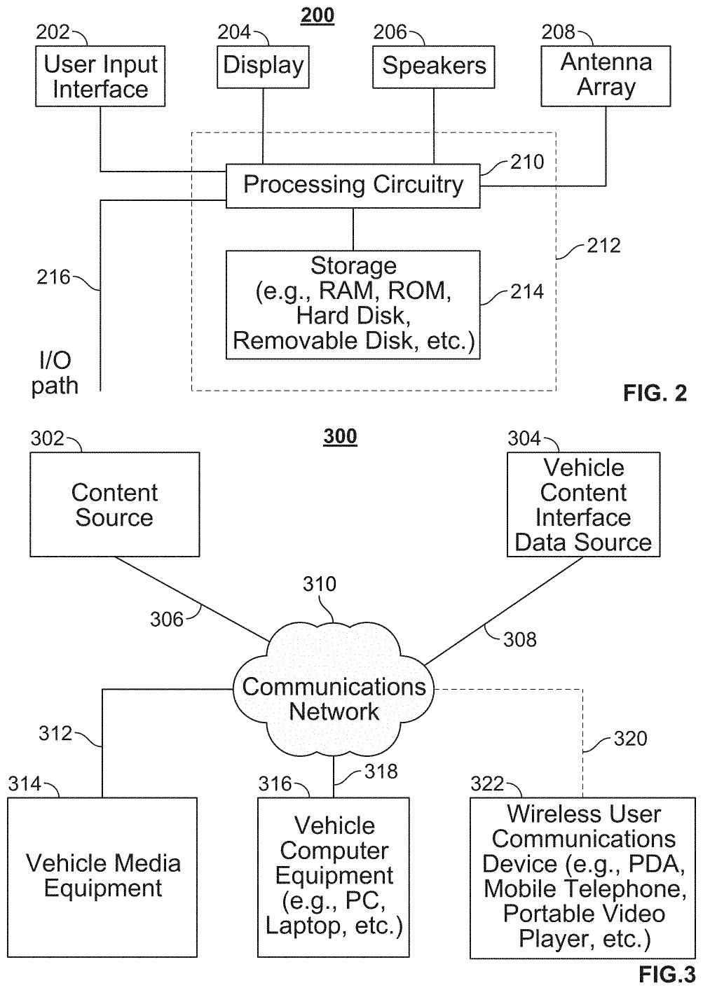

A user or occupant in a vehicle may access content and the vehicle content interface application (and its display screens described above and below) from one or more of their user equipment devices. FIG. 2 shows a generalized embodiment of illustrative user equipment device 200. More specific implementations of user equipment devices are discussed below in connection with FIG. 3. User equipment device 200 may receive content and data via input/output (hereinafter “I/O”) path 216. I/O path 216 may provide offers over a local area network (LAN) or wide area network (WAN), and data to control circuitry 212, which includes processing circuitry 210 and storage 214. Control circuitry 212 may be used to send and receive commands, requests, and other suitable data using I/O path 216.

Control circuitry 212 may be based on any suitable processing circuitry such as processing circuitry 210. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units. In some embodiments, control circuitry 212 executes instructions for a vehicle content interface application stored in memory (i.e., storage 214). Specifically, control circuitry 212 may be instructed by the vehicle content interface application to perform the functions discussed above and below. For example, the vehicle content interface application may provide instructions to control circuitry 212 to generate the audio content display. In some implementations, any action performed by control circuitry 212 may be based on instructions received from the vehicle content interface application.

In client/server-based embodiments, control circuitry 212 may include communications circuitry suitable for communicating with a merchant system server or other networks or servers. The instructions for carrying out the above-mentioned functionality may be stored on the merchant system server. Communications circuitry may include a cable modem, an integrated-services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which are described in more detail in connection with FIG. 3). In some embodiments, an antenna 208 is provided in the user equipment device 200. The antenna array 208 may be used for communication with the network of antennas. In addition, communications circuitry may include circuitry that enables peer-to-peer communication of user equipment devices, or communication of user equipment devices in locations remote from each other (described in more detail below).

Memory may be an electronic storage device provided as storage 214 that is part of control circuitry 212. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called a personal video recorders, or PVRs), solid state devices, quantum storage devices, gaming consoles, gaming media, or any other suitable fixed or removable storage devices, and/or any combination of the same. Storage 214 may be used to store various types of content described herein as well as content data and content application data that are described above. Nonvolatile memory may also be used (e.g., to launch a boot-up routine and other instructions). Cloud-based storage may be used to supplement storage 214 or instead of storage 214.

Control circuitry 212 may include video-generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 212 may also include scaler circuitry for upconverting and down-converting content into the preferred output format of the user equipment device 200. Control circuitry 212 may also include digital-to-analog converter circuitry and analog-to-digital converter circuitry for converting between digital and analog signals. The tuning and encoding circuitry may be used by the user equipment device to receive and to display, to play, or to record content. In some embodiments, the user equipment device 200, via the control circuitry, may include an HD antenna.

In one embodiment, speakers 206 may be provided as integrated with other elements of user equipment device 200 or may be stand-alone units. The audio and other content, including offers from merchants displayed on display 204, may be played through speakers 206. In some embodiments, the audio may be distributed to a receiver (not shown), which processes and outputs the audio via speakers 206.

In some embodiments, a sensor (not shown) is provided in the user equipment device 200. The sensor may be used to monitor, identify, and determine vehicular data. For example, the vehicle content interface application may receive vehicular speed data from the sensor or any other status data (e.g., global positioning data of the vehicle, driving condition of the vehicle, etc.) received from any other vehicular circuitry and/or component that describes the vehicular status of the vehicle.

The vehicle content interface application may be implemented using any suitable architecture. For example, it may be a stand-alone application wholly implemented on user equipment device 200. In such an approach, instructions of the application are stored locally (e.g., in storage 214), and data for use by the application is downloaded on a periodic basis (e.g., from an out-of-band feed, from an Internet resource, or using another suitable approach). Control circuitry 212 may retrieve instructions for the application from storage 214 and process the instructions to generate any of the displays discussed herein. Based on the processed instructions, control circuitry 212 may determine what action to perform when input is received from user input interface 202. For example, movement of a cursor on an audio user interface element may be indicated by the processed instructions when input interface 202 indicates that a user interface 600 was selected.

In some embodiments, the vehicle content interface application is a client/server-based application. Data for use by a thick or thin client implemented on user equipment device 200 is retrieved on demand by issuing requests to a server remote to the user equipment device 200. In one example of a client-server based content application, control circuitry 212 runs a web browser that interprets web pages provided by a remote server. For example, the remote server may store the instructions for the application in a storage device. The remote server may process the stored instructions using circuitry (e.g., control circuitry 212) and generate the displays discussed above and below. The client device may receive the displays generated by the remote server and may display the content of the displays locally on user equipment device 200. This way, the processing of the instructions is performed remotely by the server while the resulting displays are provided locally on user equipment device 200. User equipment device 200 may receive inputs from the user or occupant of the vehicle via input interface 202 and transmit those inputs to the remote server for processing and generating the corresponding displays. For example, user equipment device 200 may transmit, via antenna array 208, a communication to the remote server indicating that a user interface element was selected via input interface 202. The remote server may process instructions in accordance with that input and generate a display of content identifiers associated with the selected user interface element as described in greater detail with reference to FIG. 6. The generated display is then transmitted to user equipment device 200 for presentation to the user or occupant of the vehicle.

In some embodiments, the vehicle content interface application is downloaded and interpreted or otherwise run by an interpreter or virtual machine (run by control circuitry 212). In some embodiments, the vehicle content interface application may be encoded in the ETV Binary Interchange Format (EBIF), received by control circuitry 212 as part of a suitable feed, and interpreted by a user agent running on control circuitry 212. For example, the vehicle content interface application may be an EBIF application. In some embodiments, the vehicle content interface application may be defined by a series of JAVA-based files that are received and run by a local virtual machine or other suitable middleware executed by control circuitry 212. In some embodiments (e.g., those employing MPEG-2 or other digital media encoding schemes), the vehicle content interface application may be, for example, encoded and transmitted in an MPEG-2 object carousel with the MPEG audio of a program.

User equipment device 200 of FIG. 2 can be implemented in system 300 of FIG. 3 as vehicle media equipment 314, vehicle computer equipment 316, wireless user communications device 322 or any other type of user equipment suitable for accessing content, such as a non-portable gaming machine. For simplicity, these devices may be referred to herein collectively as user equipment or user equipment devices and may be substantially similar to user equipment devices described above. User equipment devices, on which a vehicle content interface application may be implemented, may function as stand-alone devices or may be part of a network of devices. Various network configurations of devices may be implemented and are discussed in more detail below.

A user equipment device utilizing at least some of the system features described above in connection with FIG. 3 may not be classified solely as vehicle media equipment 314, or vehicle computer equipment 316, or a wireless user communications device 322. For example, vehicle media equipment 314 may, like some vehicle computer equipment 316, be Internet-enabled, allowing for access to Internet content, while wireless user computer equipment 322 may, like some vehicle media equipment 314, include a tuner allowing for access to media programming. The vehicle content interface application may have the same layout on various types of user equipment or may be tailored to the display capabilities of the user equipment. For example, on wireless user computer equipment 318, the vehicle content interface application may be provided as a website accessed by a web browser. In another example, the vehicle content interface application may be scaled down for wireless user communications devices 322.

The user equipment devices may be coupled to communications network 310. Communications network 310 may be one or more networks including the Internet, a mobile phone network, mobile voice or data network (e.g., a 4G, 5G or LTE network), cable network, public switched telephone network, or other types of communications network or combinations of communications networks.

System 300 includes content source 302 and vehicle content interface data source 304 coupled to communications network 310. Communications with the content source 302 and the data source 304 may be exchanged over one or more communications paths but are shown as a using single path in FIG. 3 to avoid overcomplicating the drawing. Although communications between data sources 302 and 304 with user equipment devices 314, 316, and 322 are shown as through communications network 310, in some embodiments, data sources 302 and 304 may communicate directly 312 and 320 with user equipment devices 314, 316, and 322.

Content source 302 may include one or more types of content distribution equipment including a media distribution facility, satellite distribution facility, programming sources, intermediate distribution facilities and/or servers, Internet providers, on-demand media servers, and other content providers. Vehicle content interface data source 304 may provide content data, such as the audio described above. Vehicle content interface application data may be provided to the user equipment devices using any suitable approach. In some embodiments, vehicle content interface data from vehicle content interface data source 304 may be provided to users' equipment using a client/server approach. For example, a user equipment device may pull content data from a server, or a server may present the content data to a user equipment device. Data source 304 may provide user equipment devices 314, 318 and 322 the vehicle content interface application itself or software updates for the vehicle content interface application.

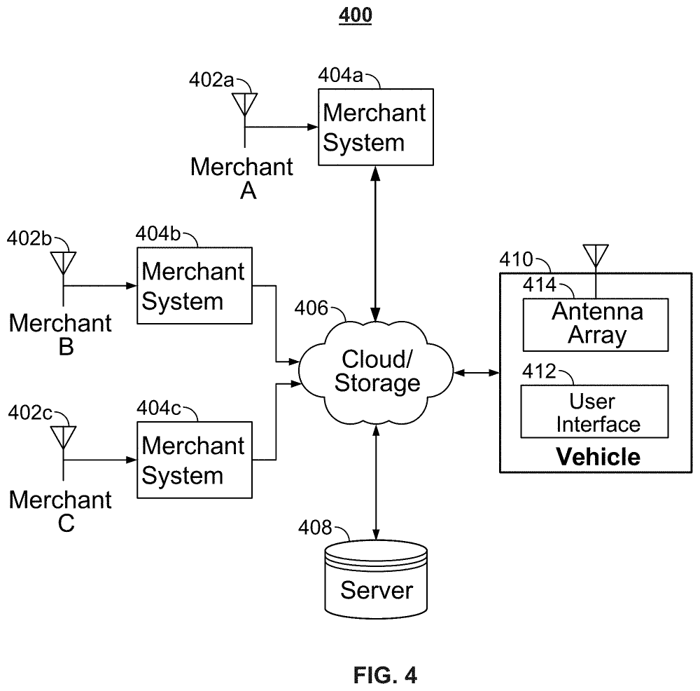

FIG. 4 shows a generalized embodiment of an illustrative system 400 in which user equipment device 200 of FIG. 2 and the system 300 of FIG. 3 can be implemented. System 400 includes an array of antennas (e.g., 402a, 402b, 402c . . . 402n) associated with a merchant and connected to merchant systems (e.g., 404a, 404b, 404c . . . 404n) coupled to storage device 406, server 408 and a vehicle 410. The vehicle 410 can communicate bidirectionally with other systems outside of the vehicle. Communications with an array of antennas (e.g., 402a, 402b, 402c . . . 402n) associated with merchants and connected to merchant systems (e.g., 404a, 404b, 404c . . . 404n) and storage device 406 may be exchanged over one or more communications paths but are shown as a single path in FIG. 4 to avoid overcomplicating the drawing.

The array of antennas (e.g., 402a, 402b, 402c . . . 402n) associated with merchants may include a plurality of antennas dispersed at each merchant location and coupled to receive and transmit data associated with offers and acceptance of offers. The antennas may be coupled to merchant systems (e.g., 404a, 404b, 404c . . . 404n) that collect all of the data associated with offers and acceptance of offers and deliver it to the storage device 406. The storage device 406 is connected to the server 408 for processing for recognition of offers and geographical location determination. The merchant offers are processed through an automated content recognition, the automated content recognition can store, allocate based on content recognition and process for presentation the offers on the user interface of the vehicle. The server 408 may be a collection of servers connected to the storage device for improved processing. The vehicle includes a user interface 412 and a vehicle antenna 414 that communicates with the storage device 406. All of the communication between the antennas, merchant systems, servers and vehicle may be through one or more networks including the Internet, a mobile phone network, mobile voice or data network (e.g., a 4G, 5G or LTE network), or other types of communications network or combinations of communications networks for in-vehicle use.

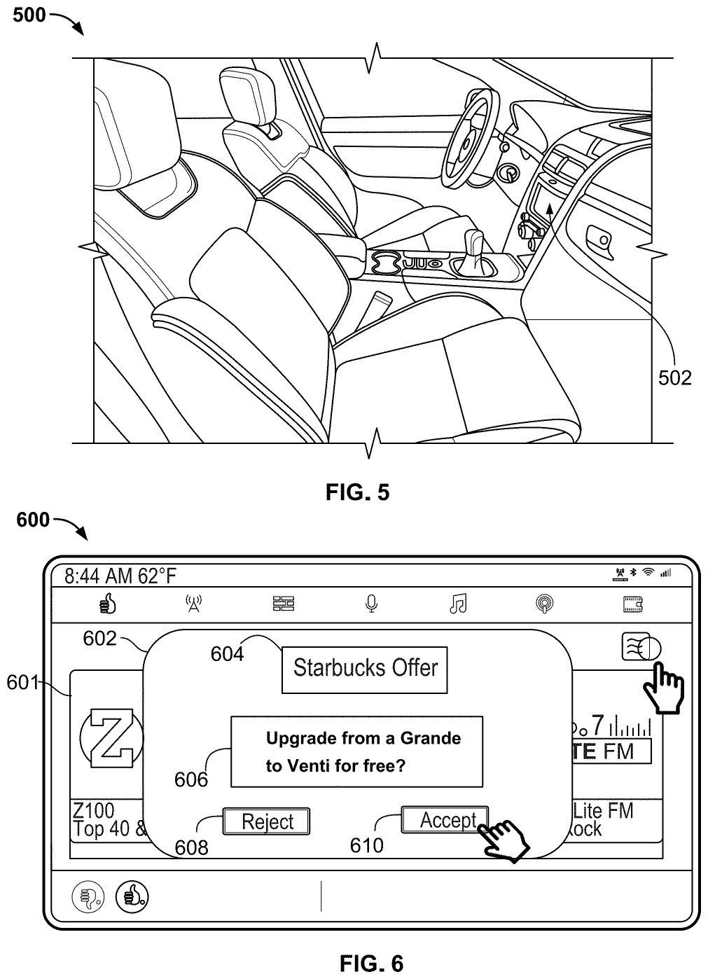

In one embodiment, user equipment may refer to components incorporated into, coupled to, or accessible by a vehicle such as vehicle 500 in FIG. 5. The vehicle 500 is equipped with a vehicle content interface application that may be used to enable/disable content options. For example, a user or occupant in a vehicle 500 may use vehicle content interface component 502 to access content in vehicle 500. In some embodiments, the vehicle content interface component 502 may be an audio system incorporated into vehicle 500 or user equipment used to access such content while using vehicle 500.

As discussed above, in some embodiments, a user or occupant of the vehicle 500 may select the user interface 600 incorporated into or accompanying the vehicle content interface component 502 by direct input into the user interface (e.g., activating the system via user interface 600 (FIG. 6). Upon a user's selection of the user interface 600, an audio user interface element 601 is displayed on the user interface 600 as shown in FIG. 6. When the system determines that the vehicle is within a first threshold distance of a merchant, the system presents an offer on the user interface 600 and prompt 602. Said prompt shows the merchant 604, the type of offer 606 and options to reject 608 or accept 610 the offer. When the user or occupant of the vehicle accepts 610 the offer via the user interface 600, incorporated into or accompanying the vehicle content interface component 502, the system transmits the acceptance and data identifying the vehicle to the merchant or merchant system.

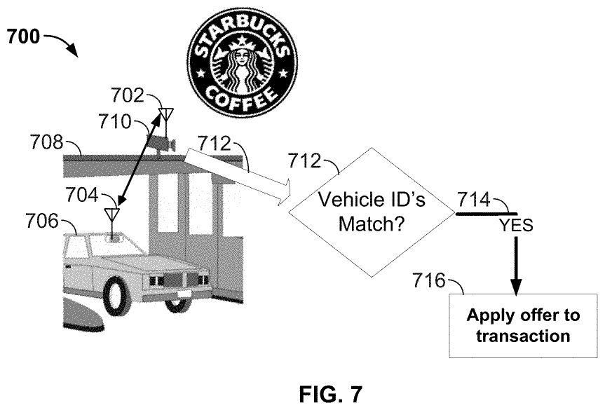

FIG. 7 depicts an illustrative example of a vehicle transmitting data to the merchant to apply an offer to a transaction, in accordance with one embodiment. In one embodiment, as shown in FIG. 7, a system 700 includes a vehicle 706 having an antenna 704 that transmits the data identifying the vehicle to the merchant 708 with an radio frequency (RF) signal receiver 710 and a merchant antenna 702 for receiving the vehicle's signal. As the vehicle drives through a drive thru of the merchant, the vehicles antenna transmits date to the merchant. The merchant then compares that data identifying the vehicle to data transmitted from the first network identifying the vehicle, and, if the data matches, the offers is applied to the transaction.

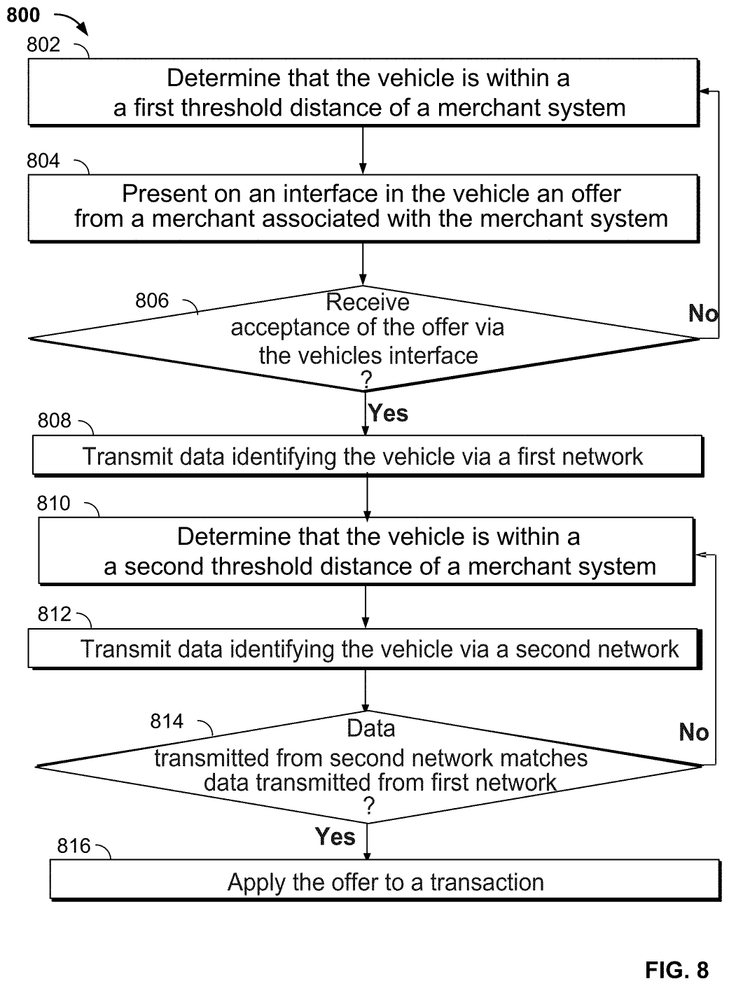

FIG. 8 depicts a flowchart of an illustrative process 800 for providing an offer to a vehicle based on vehicle identification, in accordance with some embodiments of the disclosure. As shown in FIG. 8, in accordance with some embodiments, a process 800 may be executed by processing circuitry of vehicle 200 (FIG. 2). It should be noted that process 800 or any step thereof could be performed on, or provided by, the system of FIGS. 3 and 4 or any of the devices shown in FIGS. 1, 6, and 7. In addition, one or more of processes 800 may be incorporated into or combined with one or more other steps described herein (e.g., incorporated into steps of processes 900 and 1000). For example, process 800 may be executed by control circuitry 212 (FIG. 2) as instructed by a vehicle content interface application implemented on a user device in order to provide an offer to a vehicle based on vehicle identification and geographical location. In addition, one or more steps of process 800 may be incorporated into or combined with one or more steps of any other process or embodiment. At 802, the control circuitry determines that the vehicle is within a first threshold distance of a merchant system. For example, the system may receive from a user input (e.g., via user interface 600 (FIG. 6)) selecting a criterion for a destination and predicted path and possible merchants for advertisement.

At 804, control circuitry present on an interface in the vehicle an offer from a merchant associated with the merchant system. For example, the system based on the determining that a vehicle is within the threshold distance, the system may transmit an offer to the vehicle to be presented on the user interface of the vehicle.

At 806, control circuitry determines if an acceptance from the user or occupants of the vehicle is made. If the control circuitry receives the acceptance (“Yes” at 806), then at 808, control circuitry transmits data identifying the vehicle via a first network. In some embodiments, the data transmitted may include the location of the vehicle as well as identifying information about the vehicle. The data may be presented as a first combination of data transmitted by the vehicle via a first network to the merchant system. The first combination includes the offer acceptance and the vehicle identification. If, on the other hand, control circuitry does not receive an acceptance (“No” at 806), then 802 and 804 are repeated. The process for providing an offer to a vehicle based on vehicle identification may include processing a plurality of offers from a plurality of merchants associated with variety of merchant systems. In some embodiments, a merchant may transmit a number of offers to the vehicle for the user or occupant to choose which offer to accept.

In response to transmitting data identifying the vehicle at 808, at 810, control circuitry determines that the vehicle is within a second threshold distance of a merchant system. In response to determining that the vehicle is within the second threshold, at 812, the control circuitry transmits the data identifying the vehicle via a second network to the merchant system.

At 814, control circuitry determines if the data identifying the vehicle via the first network and the data identifying the vehicle via the second network matches. If the control circuitry determines that the data matches (“Yes” at 814), then at 816, control circuitry applies the offer to a transaction. In some embodiments, the offer is applied to the transaction as the vehicle drives through a drive-thru. In another embodiment, the offer may be applied to user or occupant of the vehicle based on the vehicle identification. If, on the other hand, control circuitry does not receive an acceptance (“No” at 814), then 810 and 812 are repeated.

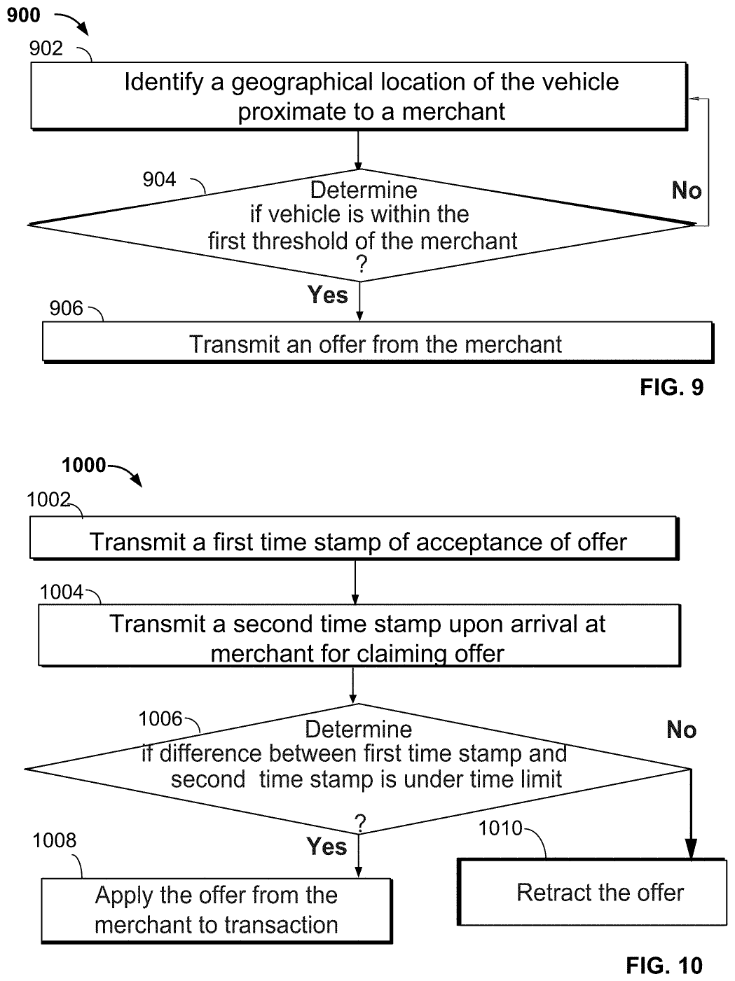

FIG. 9 depicts an example of an illustrative flowchart of the process of determining a vehicle is within a first threshold distance, in accordance with one embodiment. As shown in FIG. 9, according to some embodiments, a process 900 may be executed by processing circuitry of vehicle 200 (FIG. 2). It should be noted that process 900 or any step thereof could be performed on, or provided by, the system of FIGS. 3 and 4. In addition, one or more of processes 900 may be incorporated into or combined with one or more other steps described herein (e.g., incorporated into steps of processes 800 and 1000.

Process 900 begins at 902, where the processing circuitry may identify a geographical location of the vehicle proximate to a merchant. For example, the processing circuitry may monitor the location of the vehicle and of merchants within a first threshold. At 904, where the processing circuitry may proceed depending on the outcome of step 902, that is the system must determine if the location of the vehicle and the first threshold of the merchant overlap. For example, if the location of the vehicle is within the first threshold of the merchant, the processing circuitry may proceed to step 906. Otherwise, process 900 may return to step 902 and continue to identify a geographical location of the vehicle proximate to a merchant.

FIG. 10 depicts an example of an illustrative flowchart of the process of providing an offer based on vehicle identification information and time stamps, in accordance with one embodiment. As shown in FIG. 10, according to some embodiments, a process 1000 may be executed by processing circuitry of vehicle 200 (FIG. 2). It should be noted that processes 1000 or any step thereof could be performed on, or provided by, the system of FIGS. 3 and 4. In addition, one or more of processes 1000 may be incorporated into or combined with one or more other steps described herein (e.g., incorporated into steps of processes 800 and 900.

Process 1000 begins at 1002, where the processing circuitry may transmit a first-time stamp to a merchant based on the time of the user or occupant accepting the offer. At 1004, where the processing circuitry may proceed depends on the outcome of step 1002, that is the system must determine if a first-time stamp is obtained, and at 1004, the processing circuitry may monitor for a second time stamp based on the time the vehicle arrives at the merchant to claim the offer. For example, if the system obtains a first-time stamp and a second time stamp, the processing circuitry may proceed to step 1006. Otherwise, process 1000 may return to step 1002 and continue to identify a first-time stamp of when a vehicle accepts an offer. At 1006, the processing circuitry must determine that the time difference between the first-time stamp and second time stamp is below a time limit. For example, the user needs to claim the offer within a time limit (e.g., 30 minutes), the process circuitry checks that the difference between the time stamp the offer was accepted (e.g., first-time stamp) and the time the vehicle arrives (second time stamp) to claim the offer is within the time limit. If the control circuitry determines that the difference in time stamps is within the time limit (“Yes” at 1006), then, at 1008, control circuitry applies the offer to the transaction. If, on the other hand, the control circuitry determines that the difference in time stamps is not within the time limit (“No” at 1006), then control circuitry retracts the offer.

As used herein and in the claims that follow, the construction “one of A and B” shall mean “A or B.”

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for providing an offer based on vehicle identification, the method comprising:
determining that the vehicle is within a first threshold distance of a merchant system;
presenting on an interface in the vehicle the offer from a merchant associated with the merchant system;
in response to receiving acceptance of the offer via the vehicle's interface, transmitting data identifying the vehicle, via a first network to the merchant system;
in response to determining that the vehicle is within a second threshold distance of the merchant system, transmitting the data identifying the vehicle via a second network to the merchant system;
in response to the second network and first network data matching, applying the offer to a transaction.

2. The method of claim 1, wherein the first threshold distance is one of: a predetermined threshold distance, or an adjustable threshold distance.

3. The method of claim 1, wherein the first network is one of a 3G network, a 4G network, an LTE network, an LTE-Advanced (LTE-A) network, a Global System for Mobile Communications (GSM) network, a Code Division Multiple Access (CDMA) network, a Wideband Code Division Multiple Access (WCDMA) network, an Ultra Mobile Broadband (UMB) network, a High-Speed Packet Access (HSPA) network, an Evolution Data Optimized (EV-DO) network, a Universal Mobile Telecommunications System (UMTS) network.

4. The method of claim 1, wherein the second network is one of a Wi-Fi network, a Zigbee network, a blue-tooth network.

5. The method of claim 1, wherein the first network is one of a long-distance network, and wherein the second network is one of short-distance network.

6. The method of claim 1, wherein transmitting the data identifying the vehicle via second network to the merchant system comprises:
identifying a geographical location of the vehicle proximate to the merchant;
in response to identifying the geographical location of the vehicle is within a predetermined range of the second network of the merchant system; and
transmitting data from the vehicle to the merchant system.

7. The method of claim 1, further comprises:
in response to transmitting the data identifying the vehicle via second network to the merchant system, comparing the data transmitted, via the first network and via the second network; and
in response to the data identifying the vehicle matching, applying the offer to the transaction.

8. The method of claim 1, wherein determining that the vehicle is within the first threshold distance of the merchant system comprises:
identifying a predicted path of the vehicle;
identifying a geographical location of the vehicle proximate to the predicted path;
identifying a plurality of merchants along the predicted path having a plurality of first threshold distances; and
searching the plurality of first threshold distances along the predicted path based on the geographical location of the vehicle.

9. The method of claim 1, wherein presenting on the interface in the vehicle the offer from the merchant associated with the merchant system comprises:
identifying a predicted path of the vehicle;
identifying a geographical location of the vehicle proximate to the merchant;
in response to identifying the geographical location of the vehicle is within a range of the merchant associated with the merchant system; and
transmitting the offer from the merchant associated with the merchant system to the vehicle for presentation on a user interface.

10. The method of claim 1, wherein in response to receiving acceptance of the offer via the vehicle' interface, requesting data identifying the vehicle, via a first network.

11. The method of claim 1, further comprises:
in response to receiving acceptance of the offer via the vehicle' interface, transmitting a first-time stamp;
in response to determining that the vehicle is within the second threshold distance of the merchant system transmitting a second time stamp; and
comparing the first-time stamp and the second time stamp for a time gap against a time limit to determine if the offer is to be applied.

12. A system for providing an offer based on vehicle identification, the system comprising:
control circuitry configured to:
determine that the vehicle is within a first threshold distance of a merchant system;
present on an interface in the vehicle the offer from a merchant associated with the merchant system;
in response to receiving acceptance of the offer via the vehicle's interface, transmit data identifying the vehicle, via a first network to the merchant system;
in response to determining that the vehicle is within a second threshold distance of the merchant system, transmit the data identifying the vehicle via second network to the merchant system;
in response to the second network and first network data matching, apply the offer to a transaction.

13. The system of claim 12, wherein the first threshold distance is one of: a predetermined threshold distance, or an adjustable threshold distance.

14. The system of claim 12, wherein the control circuitry configured to transmit data identifying the vehicle via the first network, the first network is one of a 3G network, a 4G network, an LTE network, an LTE-Advanced (LTE-A) network, a Global System for Mobile Communications (GSM) network, a Code Division Multiple Access (CDMA) network, a Wideband Code Division Multiple Access (WCDMA) network, an Ultra Mobile Broadband (UMB) network, a High-Speed Packet Access (HSPA) network, an Evolution Data Optimized (EV-DO) network, a Universal Mobile Telecommunications System (UMTS) network.

15. The system of claim 12, wherein the control circuitry configured to transmit data identifying the vehicle via the second network, the second network is one of a Wi-Fi network, a Zigbee network, a blue-tooth network.

16. The system of claim 12, wherein the first network is one of a long-distance network, and wherein the second network is one of short-distance network.

17. The system of claim 12, wherein the control circuitry configured to transmit the data identifying the vehicle via second network to the merchant system comprises:
identify a geographical location of the vehicle proximate to the merchant;
in response to identifying the geographical location of the vehicle is within a predetermined range of the second network of the merchant system; and
transmit data from the vehicle to the merchant system.

18. The system of claim 12, wherein the control circuitry is further configured to:
in response to transmitting the data identifying the vehicle via second network to the merchant system, comparing the data transmitted, via the first network, and the via the second network;
in response to the data matching, applying the offer to the transaction.

19. The system of claim 12, wherein the control circuitry configured to transmit data identifying the vehicle, via the first network to the merchant system comprises:
identify a predicted path of the vehicle;
identify a geographical location of the vehicle proximate to the predicted path;
identify a plurality of merchants along the predicted path having a plurality of first threshold distances; and
search the plurality of first threshold distances along the predicted path based on the geographical location of the vehicle.

20. The system of claim 12, wherein the control circuitry is configured to present on the interface in the vehicle the offer from the merchant associated with the merchant system comprises:
identifying a predicted path of the vehicle;
identifying a geographical location of the vehicle proximate to the merchant;
in response to identifying the geographical location of the vehicle is within a range of the merchant associated with the merchant system; and
transmitting the offer from the merchant associated with the merchant system to the vehicle for presentation on a user interface.

21.-33. (canceled)
